(19) United States
(12) Patent Application Publication
(10) Pub. No.: US 2003/0084756 A1
(43) Pub. Date: May 8, 2003

(54) Vibration reducing grip for clubs and racquets

(76) Inventors: Kurt A. Schroder, Coupland, TX (US); Daniel C. Tagtow, Austin, TX (US)

Correspondence Address: HUGHES & LUCE LLP, 1717 MAIN STREET, SUITE 2800, DALLAS, TX, 75201, US

(21) Appl. No.: 10/315,611

(22) Filed: Dec. 10, 2002

Related U.S. Application Data
(63) Continuation-in-part of application No. 08/951,573, filed on Oct. 16, 1997.
(60) Provisional application No. 60/028,636, filed on Oct. 18, 1996.
(60) Provisional application No. 60/043,681, filed on Apr. 14, 1997.

(51) Int. Cl. B25D 1/00

(52) U.S. Cl. 81/20

(57) ABSTRACT

A grip is described in which longitudinal cavities are formed within the grip. The grip may be used on a golf club or tennis racket. When a golf club or racket strikes a ball, the club or racket undergoes an opposing force. This opposing force may produce various torsional or rotational vibrations within the club or racket. These forces can cause discomfort and damage to joints. The cavities act to permit material between the cavities to deform, preferentially dampening high frequency torsional vibrations and isolating the user. The cavities may also be formed to permit a user to experience low frequency oscillations while preferentially dampening the higher frequency vibrations that cause discomfort and pain. In this manner, users may experience much of the low frequency vibrations that are indicative of striking quality while avoiding discomfort associated with poor striking.

### CROSS-REFERENCE TO RELATED APPLICATIONS

This application is a continuation in part (CIP) application of U.S. patent application Ser. No. 08/951,573, entitled “Impact Instrument,” which is a continued prosecution application (CPA) of a U.S. patent application having the same serial number and title, filed Oct. 16, 1997, which claims the benefit of priority to U.S. provisional patent application, Serial No. 60/028,636, filed Oct. 18, 1996 entitled “Improved Hammering Device,” and U.S. provisional patent application, Serial No. 60/043,681, filed Apr. 14, 1997, entitled: “Hammering Device”, each of which are incorporated herein by reference in their entirety.

### TECHNICAL FIELD OF THE INVENTION

This invention in general relates to a grip for implements used in striking objects. More specifically, the invention relates to a grip for reducing vibration and isolating reaction forces from a user of an implement used in striking an object.

### BACKGROUND OF THE INVENTION

Various implements and tools are used in the striking of objects to accomplish tasks in both work and sports. These implements include hammers, claw hammers, ball-peen hammers, axes, hatchets, sledge hammers, croquet clubs, badminton rackets, clubs, golf clubs, tennis rackets, racquetball rackets, squash rackets, drum sticks, baseball bats, softball bats, cricket bats, hockey sticks, and field hockey sticks, among others. In each of these applications, an object is struck, causing a reactionary force in the striking implement. These reactionary forces may be minimized when the grip and striking point correspond to the conjugal center of percussion points on the impact instrument. However, typical users will likely strike objects at a point away from the center of percussion or “sweet spot.” Consequently, the higher than minimal reaction forces may have adverse effects on the user.

These adverse effects are especially important in the sports arena as they may include discomfort and injuries to soft tissue and joints, among others. Typical grips fail to minimize or compensate for reaction forces associated with off-center striking. As such, many people suffer from joint injuries commonly referred to as golfer's elbow or tennis elbow, among others. Other adverse effects include fatigue, poor shot quality, performance, and exacerbation of pain caused by conditions such a arthritis.

One such application is the grip of a golf club. There are multiple sources for the vibration felt by a golfer while driving a golf ball. Much of the high frequency vibration arises when the face of the club head impacts a golf ball improperly or strikes an undesired resistance such as the ground. When the ball is struck at a point away from the preferred striking area or “sweet spot” or when it is struck at a wrong angle of attack relative to the club head face, a considerable amount of torsional vibration is induced. A good drive or proper striking of the ball generates very little high frequency vibration in the club and consequently very little discomfort is felt by the user. For amateurs, high frequency vibration is typically experienced by the user on every shot. Conversely, the lack of high frequency vibration associated with a near perfect drive can be felt by the user long before he can visually see the results. Users typically want to feel low frequency vibration associated with shot quality while avoiding the high frequency vibration associated with discomfort and tissue damage.

Minimally, golf club vibration is an annoyance that interferes with users' enjoyment of the game. Often players can develop a chronic, vibration induced soreness in the hand, wrist, or elbow, among other joints, from repeated play. One such condition is medial epicondylitis and is often exacerbated by a player's age and frequency of play. Medial epicondylitis is analogous to tennis elbow and is often referred to as golfer's elbow. In some cases, exacerbation of this condition can prevent playing.

There are multiple schemes conceived to reduce the vibration felt by a golfer. Typically these schemes include modification to a club head, modification to a shaft, devices added to the golf club and the use of golf gloves, among others. Some examples include placing counter vibration weights and rods inside golf club shafts, filling the shafts with various structures, placing the coupling joints along the length of the shaft, and altering the shape of the club head, among others. In many cases, these alterations add mass to or sacrifice the structural integrity of the club. Furthermore, many of these schemes are either ineffective against vibration or make the club feel “mushy” or “sluggish”.

In addition, some of these modifications violate the rules of various golfing organizations, including the USGA and PGA rules. For example, the rules direct that a shaft should bend such that the deflection is the same regardless of the rotation of the shaft. These rules also require a circular cross-section without waists or bulges for most club grips wherein the axis of the grip must coincide with the axis of the shaft. Further, the rules require that the club head length from heel to toe be greater than the distance from front to back.

In other cases, the isolation reduces all frequencies of vibration. Low frequency club response is associated with a feeling of shot quality. High frequency club response leads to discomfort and joint damage. With the loss of low frequency, the golfer loses the feel of a good shot.

Previous grip integral vibration dampening and isolation schemes have relied on material advances such as the use of Elastom ETM®. Others have molded external grooves into the grips. These external grooves form pockets when held. These external pockets often provide limited dampening of vibrations. Further, the wrap grip structures forming these pockets often degrade and delaminate with use.

In other examples, recesses in the internal shaft cavity form pockets when a shaft is inserted. These recesses provide inadequate dampening. In addition, the internal pockets reduce the grip surface area in contact with the shaft, which can lead to delamination and degradation of the grip.

As such, many typical vibration-dampening systems suffer from deficiencies in dampening reaction vibrations and durability. Many other problems and disadvantages of the prior art will become apparent to one skilled in the art after comparing such prior art with the present invention as described herein.

### SUMMARY OF THE INVENTION

Aspects of the invention may be found in an apparatus for striking an object. The apparatus may include a shaft or handle coupled to a percussion instrument and a grip coupled to the shaft or handle opposite the percussion instrument and about a gripping region. The grip may have a plurality of elongated longitudinal cavities distributed within the grip and about the shaft. The material about the plurality of cavities may act to isolate a user from high frequency reactions to forces associated with the striking of an object. The grip may include an end cap. In an alternate embodiment, a single part may function as the grip and end cap. The end cap may seal the plurality of cavities or the plurality of cavities may be located within the end cap. Alternately, the grip may comprise an insert. The insert may have the plurality of cavities distributed within it. In another exemplary embodiment, an extruded part comprising cavities may be installed on a shaft or handle and a grip installed over or about the extruded part. The plurality of cavities may be open to the air or sealed and encapsulated. The grip may be made of various materials including Santoprene®, EPDM, and rubber, among others. The air cavities may extend parallel to the shaft. The apparatus may be a golf club or racket or other striking instrument.

Other aspects of the invention may be found in a grip for reducing the force experienced by a user when striking an object. The grip may include a plurality of elongated longitudinal cavities enclosed within the grip and distributed about a shaft. The grip may include an end cap. The end cap may function to enclose or seal the cavities. Alternately, the cap may include the cavities. The grip may also have an insert in which the cavities are distributed. The cavities may be open or closed. The cavities may extend parallel to the shaft or may spiral longitudinally, along the shaft. The material between the cavities may function to dampen high frequency responses to forces associated with striking objects.

Another aspect of the invention may be found in a method for striking an object. The method may include holding a striking implement at a grip that has a plurality of cavities distributed within the grip and about a shaft. The method further includes swinging the striking implement to strike an object wherein the striking implement reacts to a force associated with striking the object. The material between and about the cavities is permitted to deform and stretch, which acts to dampen high frequency oscillations associated with the force.

Additional aspects of the invention may be found in a method for manufacturing a grip including injecting material into a mold. A shaft or handle may be inserted into a shaft cavity of the grip. Alternately, an insert may be extruded or injection molded and the grip over molded onto the insert. Other methods include co-molding. The mold has a shape operably forming a component of the grip and the grip comprises a shaft cavity formed to fit a shaft. The component of the grip has a plurality of cavities distributed within the component and about the shaft cavity. The method may further include inserting at least one rod into the mold. The shape of the rod is associated with the shape of the plurality of cavities. Once the injection of material has taken place, the rod may be removed, leaving a cavity. Alternately, an insert having cavities may be inserted into the mold and the grip over molded onto the insert. The method may further include coupling an end cap to the grip. The end cap may seal the plurality of cavities or, alternately contain the cavities. The grip or component of the grip may be made of various materials including Santoprene®, EPDM, and rubber, among others.

As such, an apparatus for reducing reaction forces felt by users and method for manufacturing the apparatus is described. Other aspects, advantages and novel features of the present invention will become apparent from the detailed description of the invention when considered in conjunction with the accompanying drawings.

### BRIEF DESCRIPTION OF THE DRAWINGS

For a more complete understanding of the present invention and advantages thereof, reference is now made to the following description taken in conjunction with the accompanying drawings in which like reference numbers indicate like features and wherein:

FIGS. 1A, 1B, and 1C are schematic diagrams depicting an exemplary striking implement;

FIGS. 2A and 2B are schematics depicting a prior art grip;

FIGS. 3A, 3B, 4A, 4B, 5A, 5B, 6A, 6B and 7 are schematics depicting exemplary embodiments of the present invention;

FIGS. 8A, 8B, 8C and 8D are schematic diagrams depicting exemplary arrangements for the present invention; and

FIG. 9 is a block flow diagram depicting an exemplary method of manufacture for the present invention.

### DETAILED DESCRIPTION OF THE INVENTION

Various percussion instruments are used to strike objects in work tasks and sports. These include croquet clubs, badminton rackets, clubs, golf clubs, tennis rackets, racquetball rackets, squash rackets, baseball bats, softball bats, cricket bats, hockey sticks, field hockey sticks, and drum sticks, among others. In each of these cases, an object is struck with the striking tool. A reactionary force induces vibrations, oscillations, rotations, and forces within the striking tool. Depending on the location of the strike point on the tool, the reactionary forces may be stronger or weaker in the grip region and various oscillations may be induced in the striking tool. The point or location that minimizes the reactionary forces and oscillations may be a “sweet spot,” depending on the instrument and its shape or configuration.

In golf, for example, failure to hit the “sweet spot” often leads to a high frequency torsional reactionary force felt in the grip region. The reactionary force may be oscillations caused by the striking of the club or object at a non-zero angle with respect to a perpendicular line from the clubface.

These high frequency oscillations and forces minimally bring about an annoyance that interferes with the user's enjoyment of the game. The forces can induce fatigue, cause hooks and slices, reduce drive distance, and exacerbate pain associated with ailments such as arthritis. Players can often develop chronic vibration-induced soreness in the hand, wrist, or elbow, among other joints, from repeated play. Conditions such as medial epicondylitis may be exacerbated by a player's age and frequency of play. It is often analogous to tennis elbow or golfer's elbow and may be so severe that play is not possible.

Minimizing the reactionary forces and torsional vibrations may then enhance a user's performance or enjoyment of the game. Ensuring that oscillations and reactionary forces are minimally felt in the gripping region reduces the discomfort and chance of injury, hooks and slices, and fatigue. However, complete isolation of a user from the reactionary force experienced by the striking implement prevents a user from recognizing proper use of the instrument or tool. For example, a user may experience a smooth, low frequency vibration when a golf club strikes a golf ball near the “sweet spot” or, may experience high frequency short vibrations when the golf club strikes the ball off center or strikes the ground. Low frequency vibrations may be those vibrations below 200 Hz and high frequency vibrations may be those vibrations above 200 Hz. However, the frequency range of dampened or isolated vibrations may vary by design. Isolating a user from the unwanted frequencies associated with a poor striking of an object while permitting forces associated with a good or centered striking of an object permits the user to feel or ascertain the quality of the striking while avoiding damaging or annoying reactions associated with poor striking.

The following discussion shows a golf club grip that has a similar effect to a low pass filter for torsional vibrations and other reactionary forces while dampening high frequencies associated with poor striking. The golf club may also isolate a user from the vibration. However, it can be envisaged that such a grip or parts of the grip would be useful in performing similar functions in other applications.

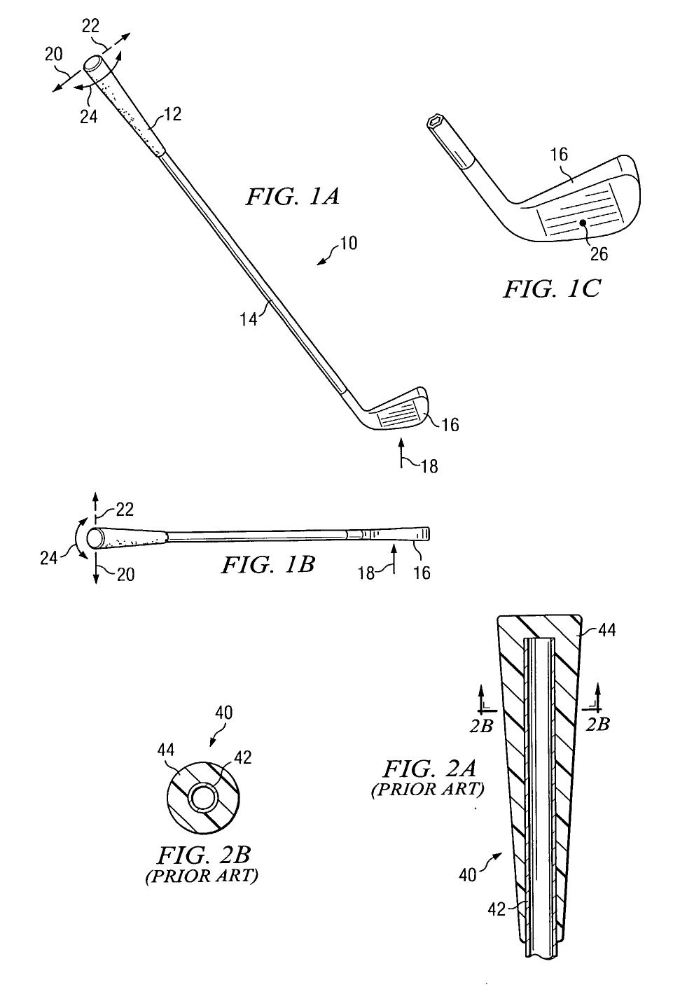

FIGS. 1A, 1B, and 1C depict an exemplary application for the present invention. These figures depict a golf club and various reactionary forces associated with the club. As seen in FIG. 1A, golf club 10 has a shaft 14 with a grip 12 on one end and a club head 16 on the opposite end. When striking a ball, a reaction force 18 is applied to the club head 16. The location of the reaction force 18 along club head 16 dictates the frequency and magnitude of reactionary forces and vibrations established in the shaft 14 and experienced in the grip 12. The location of the strike force 18 relative to the “sweet spot” determines the reactionary forces 20, 22 and 24 that may be felt by a user, holding grip 12. For example, the vibrations may be flexural in nature, producing vibrations 20 and 22. However, the larger response may be torsional vibrations 24. These vibrations travel along the shaft and are experienced by the user holding the grip 12. However, various forces, vibrations and oscillations may be envisaged and depend on the location of the striking force 18 relative to various positions on club head 16.

In addition, torsional vibrations can be induced by the initial back swing of the club. These vibrations can lead to exacerbated slicing and hooking upon striking the ball. The induced torsional vibrations from the initial backswing may cause the clubhead to impact the ball at an improper angle thereby leading to a possible hook or slice. Dampening of these vibrations reduces their amplitude.

FIG. 1B is a schematic diagram depicting an overhead view of the club head. Here the strike force 18 is depicted striking club head 16. Depending on the location of force 18, the reactionary forces 20, 22 and 24 may or may not be experienced and may or may not be minimized. FIG. 1C is an exemplary depiction of a club head. On the club head there may exist a point 26 that is often called the “sweet spot.” Typically, the ball rolls along the surface of the club face during impact and the striking plate acts like a spring board. The impact lasts approximately 500 μs and is often over before the user feels it. If the ball is struck at the sweet spot 26 or if the ball hits the sweet spot 26 during the striking motion, the high frequency torsional forces and vibrations may be minimized.

Striking a ball with a golf club away from the sweet spot 26 of the club head 16 causes various rotational vibrations to be experienced by a user at grip 12. Striking the ground or other impedances may also result in undesired vibration. These forces minimally cause discomfort and annoyance to a user. Additionally, they may cause damage to soft tissue and joints. High frequency torsional vibrations may also lead to fatigue and poor shot quality. For example, these vibrations may lead to more slices, hooks, short drives and other lower quality drives.

On the other hand, certain types of low frequency vibrations and reactionary forces indicate the quality of the swing to a user. As such, users want to feel specific low frequency reactions while avoiding other high frequency vibrations. Various analogies may be drawn to other striking tools and implements.

FIGS. 2A and 2B represent existing grips 40. FIG. 2A is a side view slice of an exemplary prior art grip and FIG. 2B is a top view slice of the prior art grip. Any forces experienced in shaft 42 are transferred through grip 44 to the hands of the user. As such, the user experiences both the annoying and damaging high frequency torsional forces caused by off-sweet-spot impacting and the low frequency forces. Such a club grip may lead to soreness in elbows and joints in addition to chronic damage or pain such as medial epicondylitis. In addition, the grip seen in FIGS. 2A and 2B may lead to fatigue and poor shot quality.

Other grips suffer from similar deficiencies. These grips include wraps and variations on wrap designs.

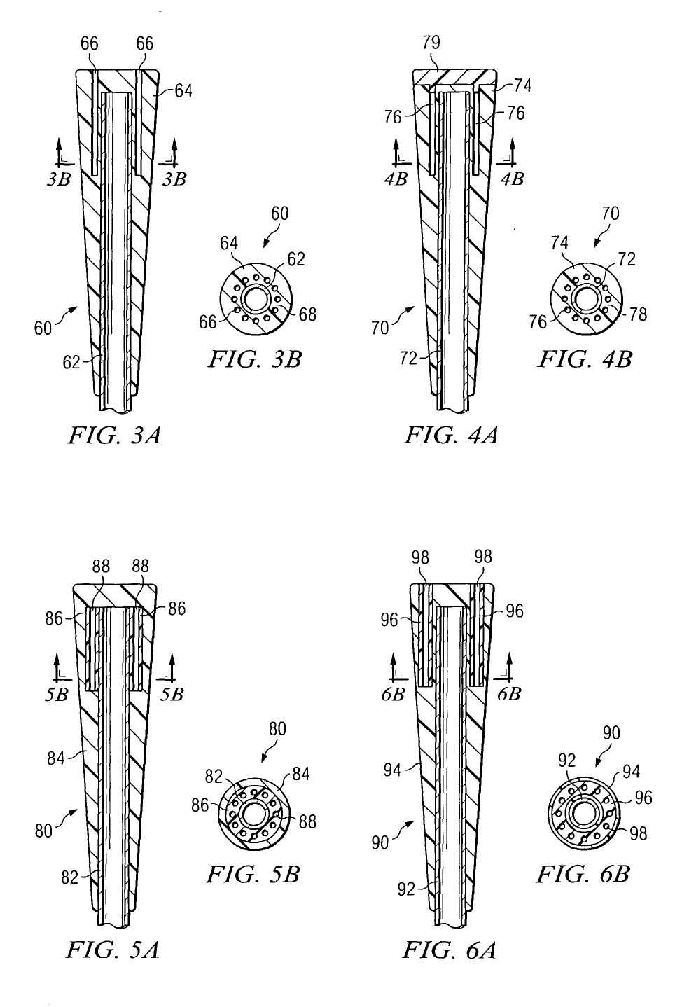

FIGS. 3A and 3B are schematic diagrams depicting an exemplary embodiment of the present invention 60. In this exemplary embodiment, a grip 64 surrounds a shaft 62. Within the grip 64 and distributed about the shaft 62 are cavities 66. The cavities 66 are depicted as circular elongated cavities extending longitudinally parallel to the shaft 62. When subjected to torsional vibrations, the material 68 between and about the cavities 66 deforms, stretches, and compresses, into and around the cavities 66. These deformations result in a dampening of the torsional vibrations and isolation of the vibrations from the user.

The material 68 and cavities 66 may form a dampener or filter. High frequency components of the vibration are preferentially damped more than the low frequency components. The high frequency components are associated with discomfort and joint pain. The low frequency components are associated with the feeling of the impact and help the user ascertain the quality of the shot. The grip, therefore, eliminates the painful sting associated with an off-sweet-spot shot while retaining the feel of the impact. The dampening may be tuned by varying the number, shape, and/or size of the cavities.

The cavities are distributed within the grip material 64 and do not touch the shaft 62. As a result, the grip 64 contacts the complete surface area of shaft 62. This complete contact provides more surface area for applying adhesive force between the shaft 62 and grip 60, preventing slippage and eliminating typical adhesion problems.

In addition, the cavities compress slightly when the grip is grasped by a user. As a result, the grip conforms to the user's hand, enabling a more secure, stronger grip without excess exertion by the user.

The cavities also reduce the weight of the grip. This weight reduction enables a higher club head speed and subsequently, longer drives.

The material 68 of the grip 64 may take various forms including Santoprene®, EPDM, and various plastics, thermoplastics, elastomers, composites, and natural and synthetic rubbers, among others. The grip may be over-wrapped, be designed to install in a manner similar to a wrap, or be installed like a push-on grip.

The cavities 66 may take various forms and cross-sectional shapes. They may extend longitudinally parallel to the shaft. Alternately, they may spiral longitudinally or form other patterns. In addition, the cavities 66 may be opened to or sealed from the environment.

Together, these various features provide a grip that is more comfortable and enjoyable for the average golfer. The design allows for easy installation, removal, re-installation, and manufacture. Inserts may be over molded into the grip. In addition, it lacks the durability problems associated with wrap-type grips or grips without complete contact with the shaft. Moreover, the grip may conform to USGA rules.

FIGS. 4A and 4B show a similar exemplary embodiment 70 with an end cap 79. In this example, grip 74 surrounds shaft 72. Cavities 76 are distributed within the grip 74 and around the shaft 72. End cap 79 attaches to the grip 74 and functions to seal or encapsulate the cavities 76. Similar to the embodiments seen in FIGS. 3A and 3B, this exemplary embodiment functions to dampen torsional vibrations. The material 78 between and about cavities 76 deforms, compresses, and stretches, into and with the cavities 76, dampening the high frequency vibrations and preventing the user from experiencing them.

The end cap may be made of various materials, including Santoprene®, EPDM, and various plastics, thermoplastics, elastomers, composites, and natural and synthetic rubbers, among others. The end cap may be made of the same material or a different material from the grip 74.

FIGS. 5A and 5B depict an alternate embodiment 80 of the present invention in which an insert 86 surrounds the cavities 88. The grip 84, including the insert 86, surrounds the shaft 82 and makes contact completely around the shaft 82. The insert 86 may be made of various materials including Santoprene®, EPDM, and various plastics, thermoplastics, elastomers, composites, and natural and synthetic rubbers, among others. These materials may be the same or different from the materials of the main grip 84.

The cavities may take various shapes and forms and may extend longitudinally parallel to the shaft. Alternately, the cavities may extend parallel to the shaft in various patterns including spirals. The cavities may be opened to the environment or closed as shown.

The insert may contact the shaft as shown. Alternately, the insert may be placed within and surrounded by the main grip material. The insert may be injection molded or extruded. The main grip material may then be over molded onto the insert or molded in such a manner as to form to the insert. In another example, the insert may be installed directly on the shaft and a grip placed over or about the insert.

An exemplary embodiment 90 may be seen in FIGS. 6A and 6B in which the insert 96 is surrounded by the main grip material 94. The main grip material 94 completely surrounds the shaft 92. In this exemplary embodiment, the cavities 98 surrounded by the insert 96 are open to the environment.

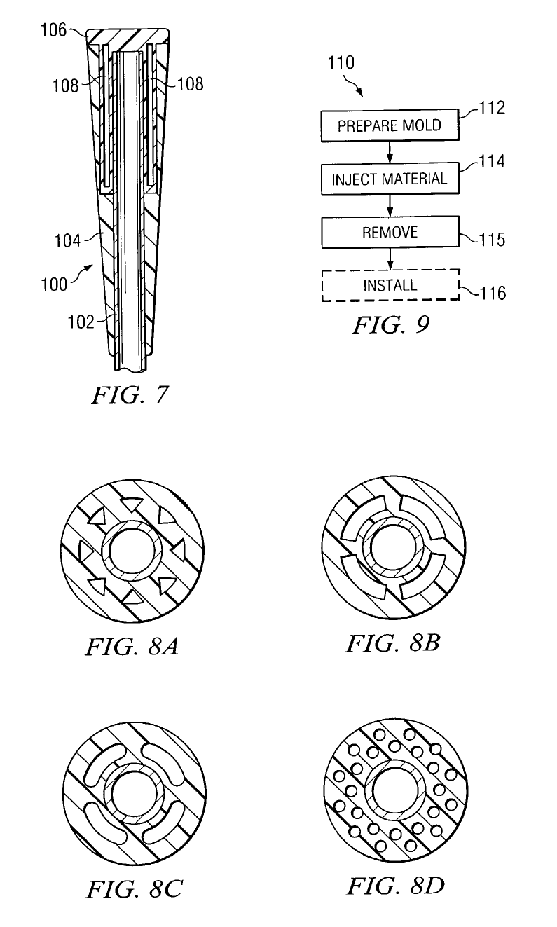

FIG. 7 shows a further exemplary embodiment 100 in which the end cap and insert are combined. The end cap 106 surrounds the cavities 108. The end cap 106 may or may not contact the shaft 102. The grip 104 surrounds portions of the end cap and the shaft 102. The end cap 106 and main grip material 104 may be made of the same material or different. The cavities 108 may be encapsulated or open to the environment.

FIGS. 8A, 8B, 8C and 8D depict various embodiments of cavities and their distribution. FIG. 8A depicts substantially triangular cavities distributed radially about a shaft and completely surrounded by the material of the grip. FIG. 8B depicts curved trapezoidal-like cavities within the grip material and distributed radially about a central shaft. In other embodiments, FIG. 8C depicts peanut-shaped cavities distributed about a central shaft and FIG. 8D depicts circular shaped or cross-sectioned cavities distributed on differing radii, radially about a central shaft. In each of these embodiments, the shape of the cavity or cross-section of the cavity differs. In addition, the shape or cross-section of the material between the cavities differs. The shape and quantity of the cavities therefore dictate the shape of the material between the cavities. The shape of the material between the cavities may affect various functional dampening and deformations that compensate for varying vibrations. As such, various cavity cross-section, distribution patterns, and number of cavities may be used in combination to produce the desired dampening effect or isolation of the user from the specific vibrations in the shaft.

One can also envisage various asymmetric designs for grips and cavity placement. In addition, the shape of the cavities may be varied. However, in the exemplary embodiment of the golf club, the grip may conform to USGA rules.

Various methods of manufacture may be envisaged for the grip. FIG. 9 depicts an exemplary method 110. A mold associated with the shape of the grip is prepared as seen in a step or block 112. The preparation may include the insertion of rods or other components that affect the distribution, shape and number of cavities within the grip. The preparation may also include placing an insert for over molding. The mold may also allow for a shaft cavity.

As seen in a block 114, the mold is then injected, inoculated, or filled with the grip material. This material may include Santoprene®, EPDM, and various plastics, thermoplastics, elastomers, composites, and natural and synthetic rubbers, among others.

Once the material is cured, set, crystallized, or cooled, the grip may be removed as seen in a block 115. This removal may include the removal of rods or components that establish the cavities in addition to the removal of the grip from the mold. This method may also be used for components that make up the grip, including end caps and inserts in which the cavities are formed. These inserts or end caps may also be placed in a further mold and a grip over molded around it. Alternately, multiple materials may be injected into the mold simultaneous or in various orders to produce regions with differing qualities.

Then, the grip or the various component parts of the grip may be installed on a shaft as seen in a block 116. For example, the grip may be inserted onto the end of a shaft such as that of a golf club.

As such, a grip and method of manufacturing the grip is described. In view of the above detailed description of the present invention and associated drawings, other modifications and variations will now become apparent to those skilled in the art. It should also be apparent that such other modifications and variations may be effected without departing from the spirit and scope of the present invention as set forth in the claims, which follow.

What is claimed is:

1. An apparatus for striking an object, the apparatus comprising:
a shaft coupled to a percussion instrument;
a grip coupled to the shaft opposite the percussion instrument and about a gripping region, the grip comprising a plurality of longitudinal cavities distributed within the grip about the shaft.

2. The apparatus of claim 1, wherein the grip further comprises:
an end cap, the end cap sealing the plurality of longitudinal cavities.

3. The apparatus of claim 1, wherein the grip further comprises:
an end cap, the plurality of longitudinal cavities distributed within the end cap.

4. The apparatus of claim 1, wherein the grip comprises:
an insert, the plurality of longitudinal cavities distributed within the insert.

5. The apparatus of claim 1, wherein at least one of the plurality of longitudinal cavities is open.

6. The apparatus of claim 1, wherein at least one of the plurality of longitudinal cavities is encapsulated.

7. The apparatus, of claim 1, wherein the grip comprises Santoprene®.

8. The apparatus of claim 1, wherein the grip comprises rubber.

9. The apparatus of claim 1, wherein the grip comprises EPDM.

10. The apparatus of claim 1, wherein the grip comprises elastomeric material.

11. The apparatus of claim 1, wherein the apparatus comprises a golf club.

12. The apparatus of claim 1, wherein the apparatus comprises a racket.

13. The apparatus of claim 1, wherein the plurality of longitudinal cavities extend longitudinally parallel to the shaft.

14. The apparatus of claim 1, wherein the plurality of longitudinal cavities extend longitudinally and spiral about the shaft.

15. The apparatus of claim 1, wherein the material about the plurality of longitudinal cavities acts to isolate a user from high frequency reactions to a force associated with striking an object.

16. A grip for reducing forces experienced by a user when striking an object, the grip comprising:
a plurality of longitudinal cavities enclosed within the grip and distributed about a shaft.

17. The grip of claim 16, wherein the grip further comprises:
an end cap, the end cap sealing the plurality of longitudinal cavities.

18. The grip of claim 16, wherein the grip further comprises:
an end cap, the plurality of longitudinal cavities distributed within the end cap.

19. The grip of claim 16, wherein the grip comprises:
an insert, the plurality of longitudinal cavities distributed within the insert.

20. The grip of claim 16, wherein at least one of the plurality of longitudinal cavities is open.

21. The grip of claim 16, wherein at least one of the plurality of longitudinal cavities is encapsulated.

22. The grip of claim 16, wherein the grip comprises Santoprene®.

23. The grip of claim 16, wherein the grip comprises rubber.

24. The grip of claim 16, wherein the grip comprises EPDM.

25. The grip of claim 16, wherein the grip comprises elastomeric material.

26. The grip of claim 16, wherein the plurality of longitudinal cavities extend longitudinally parallel to the shaft.

27. The grip of claim 16, wherein the plurality of longitudinal cavities extend longitudinally and spiral about the shaft.

28. The grip of claim 16, wherein the material about the plurality of longitudinal cavities acts to isolate a user from high frequency reactions to a force associated with striking an object.

29. A method for manufacturing a grip, the method comprising:
injecting at least one material into a mold, the mold having a shape associated with at least a component of the grip, the grip comprising a shaft cavity formed to fit a shaft, the component of the grip comprising a plurality of longitudinal cavities distributed about the shaft cavity; and
inserting a shaft into a shaft cavity.

30. The method of claim 29, the method further comprising:
inserting at least one rod into the mold, the shape of the at least one rod being associated with at least one of the plurality of longitudinal cavities; and
removing the at least one rod after the step of injecting material.

31. The method of claim 29, wherein the material comprises Santoprene®.

32. The method of claim 29, wherein the material comprises EPDM.

33. The method of claim 29, wherein the material comprises rubber.

34. The method of claim 29, wherein the material comprises elastomeric material.

35. The method of claim 29, the method further comprising:
coupling an end cap to the grip.

36. The method of claim 35, wherein the end cap seals at least one of the plurality of longitudinal cavities.

37. A method for striking an object, the method comprising:
holding a striking implement at a grip, the grip comprising a plurality of longitudinal cavities enclosed within the grip and distributed about a shaft; and
swinging the striking implement to strike the object, the striking implement reacting to a force associated with the object, the material about the plurality of longitudinal cavities acting to dampen high frequency oscillations associated with the force.
